(19) United States
(12) Patent Application Publication
(10) Pub. No.: US 2009/0008316 A1
(43) Pub. Date: Jan. 8, 2009

(54) Filter Plate for Use in a Filter Stack

(76) Inventors: John Verhaeghe, Deerlijk (BE); Johan Hugelier, Harelbeke (BE); Martin Van Haeke, Izegem (BE); Johan Van Meenen, Kluisbergen (BE)

Correspondence Address: BACON & THOMAS, PLLC, 625 SLATERS LANE, FOURTH FLOOR, ALEXANDRIA, VA, 22314-1176, US

(21) Appl. No.: 12/224,294

(22) PCT Filed: Feb. 20, 2007
(86) PCT No.: PCT/EP2007/001445

§ 371 Date: Aug. 22, 2008

(30) Foreign Application Priority Data
Feb. 23, 2006 (EP) 06003657.1

(51) Int. Cl. B01D 25/12

(52) U.S. Cl. 210/230; 210/231

(57) ABSTRACT

A filter plate for filtration (100) of a fluid as subject of the present invention comprises a first filter membrane (110) and a second filter membrane (120). The filter membranes are substantially planar and substantially-parallel. The filter membranes comprise metal fibers. The filter plate comprises a reinforcing means (130, 131) interposed between the filter membranes. The first and second filter membrane are attached to the reinforcing means. The reinforcing means creates at least two flow channels (132) between the filter membranes for guiding a fluid towards the edge of the filter plate.

### TECHNICAL FIELD OF THE INVENTION

The present invention relates to filter plates, and more in particular to filter plates and filter stacks for use in a filter system as well as to methods of manufacturing such filter plates.

### BACKGROUND OF THE INVENTION

Filter systems using filter plates are well known in the art. As an example, a filter press is described in WO2005/028070. A number of filter membranes are stacked together with means to create chambers at each side of the filter membrane for receiving fluid to be filtered or for evacuation of filtrate. The stacking of membranes and means for creating chambers is to be done very accurately and carefully in order to avoid leakage and/or mixing of filtrate with fluid to be filtered. Dismantling of the press filter is to be done quite often in order to clean the press filter, when the filter is clogged with particles retained from the fluid. Assembling and dismantling requires a significant amount of time, is labour intensive and causes a significant downtime for the press filter.

Other systems for filtering fluids are also known, such as the use of leaf discs, being concentrically mounted on a tube for discharging the filtrate from the leaf discs. The clogged filter is usually cleaned by back flushing, back pulsing or back washing. During such cleaning operation, fluid is provided in reverse direction in order to disconnect and break the cake built up at the inflow side of the filter membranes and remove it from the filter.

In general, filter plates are shown in FIG. 6a and FIG. 6b of WO2004/004868. Two filter membranes are mounted substantially parallel to provide a filter plate. Each membrane is provided with a reinforcing structure. Between the two membranes, a metal wire grid or an expanded metal sheet is placed in order to maintain the distance between two membranes, e.g. during cleaning.

Such plates have some disadvantages. Due to vibrations, shocks or changing fluid pressure, the mesh or expanded plate may dislocate and thereby damage the interior of the plate, i.e. the membrane. The mesh also creates a pressure drop over the filter plate, which both reduces the yield of filtrate obtained using given filtration pressure, and makes back washing, back flushing or back pulsing difficult if not impossible.

The filter plate is at least partially closed at its circumference with a sealing means. This sealing means is provided between the two substantially parallel filter membranes. In order to resist higher pressures during filtration, the spacer means is to contact the inner sides of the membranes. However, in several filter systems, as an example but not limited to filter presses, when several plates are to be stacked to form a stack of filter plates, the sealing of the plates is subjected to very small tolerances. This is necessary in order to avoid leakages. The meshes or expanded plates, which are to contact the inner sides of the filter membranes to provide sufficient support, are to meet these small tolerances as well, which is often problematic or even impossible. The lager tolerances met by the mesh or expanded plates, cause either insufficient support when the mesh or expanded plate does not contact the membrane, or cause the membrane to bulge outwards, in a direction pointing away from the mesh or expanded plate. In case a supporting g means, i.e. a metal wire mesh or expanded metal sheet, is present, the membranes may be squeezed between two meshes or expanded plates, one at both sides of the membrane.

### SUMMARY OF THE INVENTION

It is an object of the present invention to provide an alternative filter plate and methods of making the same, for use in filter systems such as filter presses, back washing filter systems, back pulsing filter systems or back flushing filter systems. It is an advantage of some embodiments of the present invention to provide a filter plate, which comprises fewer spare parts as the presently known filter plates. It is also an advantage of some embodiments of the present invention to provide a filter plate which is equally or more resistant to pressure variations, shocks and/or vibrations. It is also an advantage of some embodiments of the present invention to provide a filter plate, whose filter membranes are less vulnerable to defects caused by pressure variations, shocks and/or vibrations during filtration, or because of imprecise assembling of the filter system. It is an advantage of some embodiments of the present invention to provide a self supporting filter plate.

It is an advantage of some embodiments of the present invention to provide a filter plate meeting the tolerances necessary to seal the different plates and membranes of the plates more easily, more reproducible and more reliable when the filter plates are used to provide a filter stack comprising several adjacent filter plates as subject of the present invention. It is also an advantage of embodiments of the present invention to provide a filter plate, which allows an easy separation between liquid to be filtered and filtrate. It is a well an advantage of some of the embodiments of the present invention to provide a filter plate, which provides only a small pressure drop over the filter plate. It is also an advantage of embodiments of the present invention to provide a filter plate, which has a very uniform flux of liquid passing through the filter plate. It is an advantage of some embodiments of the present invention to provide a filter plate allowing individual use of only one filter plate.

It is an advantage of some embodiments of the present invention to provide a filter system whose yield of filtrate obtained when filtering using given filtration pressure, is increased while allowing back washing, back flushing or back pulsing to clean the filter membranes

It is an advantage of some embodiments of the present invention to provide a filter system, which is well resistant to back washing, back flushing or back pulsing. It is also an advantage of some embodiments of the present invention to provide a filter system, which do not require additional support of the filter membranes to resist back washing, back flushing or back pulsing. It is an advantage of some embodiments of the present invention to provide a filter stack, which is easier to assemble. It is an advantage of some embodiments of the present invention to provide a filter stack, which comprises fewer spare parts as the presently known filter plates. It is an advantage of some embodiments of the present invention to provide a filter system which can be cleaned more efficiently by back washing, back flushing or back pulsing.

It is a further advantage of embodiments having a polymer reinforcing means that then it is easier to meet the strict and narrow tolerances of the parts of the filter plate. It was found that, when using polymer parts such as polymer rods or plates, especially for the purpose of reinforcing the filter membranes, these polymer parts show less or no distortion as compared with e.g. similar metal parts when being fixed to the filter membrane. It is further an advantage that the parts can be mounted and fixed at lower temperatures, which reduces the risk on damage to the filter membrane, which damage may occur than the filter membrane is locally heated too much. It further has the advantage to provide less heavy filter systems, which have a lower risk on corrosion, such as galvanic corrosion, of the metal elements in the filter system, e.g. the filter membranes.

A filter plate according to the present invention accomplishes the above objective.

According to a first aspect of the present invention, a filter plate for filtration of a fluid has an edge and comprises a first filter membrane and a second filter membrane, which filter membranes are substantially planar. The first filter membrane and the second filter membrane are substantially parallel. The first filter membrane and the second filter membrane comprise metal fibers. The filter plate comprises a reinforcing means interposed between the filter membranes, and the first filter membrane and second filter membrane are attached to this reinforcing means. The reinforcing means creates at least two flow channels between the filter membranes for guiding the fluid towards the edge.

According to embodiments of the present invention, the reinforcing means is provided from polymer material. According to other embodiments of the present invention, the reinforcing means is provided from metal material.

According to embodiments of the present invention, the first filter membrane and the second filter membrane may comprise ceramic material such as ceramic fibers. According to embodiments of the present invention, the fibers from the first filter membrane and the second filter membrane may be a mixture of metal fibers and ceramic fibers. According to embodiments of the present invention, all fibers from said first filter membrane and said second filter membrane may be metal fibers. According to embodiments of the present invention, the first filter membrane and the second filter membrane may consist of fibers.

According to embodiments of the present invention, the first filter membrane and the second filter membrane further may comprise at least one of a metal wire grid or an expanded metal sheet. According to embodiments of the present invention, the first filter membrane and the second filter membrane may comprise powder, possibly a power selected from the group consisting of metal powder, ceramic powder and a mixture of metal powder and ceramic powder.

According to embodiments of the present invention, the first filter membrane and the second filter membrane may consist of metal fibers, or the first filter membrane and the second filter membrane may consist of metal fibers and at least one of a metal wire grid or an expanded metal sheet.

According to embodiments of the present invention, each of the flow channels having two outer ends along the edge. The filter plate may comprise a plate closing means being attached to the edge along at least part of the edge other than the outer ends of the channels. the plate closing means may be provided between the first filter membrane and the second filter membrane for sealing the filter plate along this at least part of the edge. According to embodiments to the present invention, the sealing means seals one of the two outer ends of each of the flow channels.

According to embodiments of the present invention, the filter plate may have two outer sides facing away from the reinforcing means. The filter plate further comprises a gasket being attached to at least one of the outer sides of the filter plate along at least part of the edge for creating at least one flow channel, for guiding the fluid between two filter plates when two filter plates are stacked one to the other. The gasket may be provided at both of said outer sides of said filter plate. According to some embodiments, the gasket may form one part with said plate closing means.

According to embodiments of the present invention, the spacer means may be a corrugated plate. According to other embodiments of the present invention, the spacer means may be a plate having two outer sides, on each of these sides, the plate may have a plurality of ribs protruding out of this side.

According to still other embodiments of the present invention, the spacer means may consist of a plurality of rods. The rods may have a substantially rectangular cross section. The rods may be attached to only one of the first filter membrane and the second filter membrane, at least one of the rods being attached to the first filter membrane and at least one of the rods being attached to the second filter membrane. Alternatively, the each of the rods may be attached to both of the first filter membrane and the second filter membrane.

According to embodiments of the present invention, the filter plate may have a substantially rectangular shape. The filter plate may have a first side and a second side being substantially perpendicular to the first side, the rods may be substantially parallel to each other and to one of the first side and the second side.

According to embodiments of the present invention, the filter plate may have a substantially circular shape having a substantially circular outer edge. The filter plate may have a substantially circular open area being concentric with the substantially circular shape of the filter plate and providing a substantially circular inner edge. Each of the rods may extend from the centre of the circular shape to the outer edge, thereby providing two outer ends to each flow channel along the edge, a first outer end being provided at the inner edge, and the second outer end being provided at the outer edge.

According to embodiments of the present invention, at least one of the first filter membrane or the second filter membrane may comprise at least a first metal fiber layer which metal fibers of the at least first metal fiber layer have an equivalent diameter D1, the at least one of the first filter membrane or the second filter membrane has a mean flow pore size of less than 2 times the equivalent diameter D1.

According to embodiments of the present invention, at least one of the first filter membrane or the second filter membrane may comprise at least a second metal fiber filter layer.

According to embodiments of the present invention, the second metal fiber layer may comprise metal fibers having an equivalent diameter D2 being larger than the equivalent diameter D1 of the metal fibers of the first metal fiber layer.

According to embodiments of the present invention, the first filter membrane and the second filter membrane may be identical.

According to a second aspect of the present invention, a filter stack is provided, which pack comprises at least two filter plates according to the first aspect of the present invention. The at least two filter plates being stacked one to the other, are provided with means for creating at least one flow channel for guiding a fluid between the filter plates when two filter plates being stacked one to the other.

According to embodiments of the present invention, the means for creating at least one flow channel for guiding a fluid between the filter plates when two filter plates being stacked one to the other may consist in a gasket being attached to at least one of the outer sides of the filter plate along at least part of the edge of the filter plate.

According to a third aspect of the present invention, a filter system is provided, comprising at least two filter plates according to the first aspect of the present invention. According to embodiments of the present invention, a filter system may comprise at least one filter stack according to the second aspect of the present invention.

According to embodiments of the present invention, the filter system may be a press filter system. According to embodiments of the present invention, the filter system may be a back flush filter system, a back wash filter system or a back pulse filter system.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 and FIG. 2 are schematically view of a filter plate as subject of the present invention.

FIG. 3 is a schematically view of a filter stack as subject of the present invention.

FIG. 4a, FIG. 4b, FIG. 4c and FIG. 4d are schematically views of a detail of embodiments of the filter plates as subject of the present invention.

FIG. 5 and FIG. 5b are schematically views of alternative embodiments of filter plates as subject of the present invention.

In the different figures, the same reference signs refer to the same or analogous elements.

### DEFINITIONS

The following terms are provided solely to aid in the understanding of the invention. These definitions should not be construed to have a scope less than understood by a person of ordinary skill in the art.

The term “fluid” is to be understood as any gas or liquid. The filter plates, filter stacks and filter systems according to the present invention are however preferably used for filtration of liquids, such as edible liquids, e.g. beverages like beer, wine, fruit juice or alike, or oils such as olive oil. The filter plates, filter stacks and filter systems according to the present invention may be used for non-edible fluids, e.g. machine oil or emulsions such as cutting oil, coolants, liquids or gasses out of which catalytic elements may be recovered, bio-ethanol or biodiesel, or fluids from pharmaceutical, biochemical or biomedical applications.

The term “metal fiber” is to be understood as a fiber being provided out of any metal alloy, however preferably out of stainless steel alloys such as AISI316 or AISI316 alloys e.g. AISI316L. Metal fibers may be provided by different suitable production processes such as e.g. bundle drawing process according to U.S. Pat. No. 3,379,000, coil shaving process such as known from EP319959 or metal fibers provided by melt extraction such as described in U.S. Pat. No. 5,027,886. Metal fibers are characterised by an equivalent diameter, for the invention preferably in the range of 1 μm to 120 μm, such as in the range of 1 μm to 60 μm. The fibers may be endless long fibers (also referred to as filaments) or may be provided as staple fibers having an average length in the range of 1 mm to 90 mm. Possibly the metal fibers are short metal fibers. The metal fibers may be cut using the method as described in WO02/057035, or by using the method to provide metal fiber grains such as described in U.S. Pat. No. 4,664,971. A combination of short metal fibers and staple metal fibers may as well be used, comprising up to 20% in weight of staple metal fibers.

The term “equivalent diameter” of a fiber is the diameter of an imaginary circle having a surface area, equal to the average surface area of a radial cross section of said fiber.

The term “filter membrane” is to be understood any membrane, which is able to separate slid particles from a fluid, preferably a liquid. The filter membranes used for the present invention may be suitable for surface filtration as well as depth filtration. Filter membranes preferably have a thickness in the range from 0.025 mm to 2 mm, and may have a porosity P in the range of 40% to 95%. Possibly metal fibers may be blend with ceramic fibers and/or with ceramic powder and/or ceramic whiskers and/or metal powder. Possibly the particles are provided with a catalytic component and act as a catalyst carrier.

Preferably the particle diameter is less than ⅕ of the equivalent diameter of the fibers used. The ceramic fibers or powder may be made out of Al₂O₃, SiO₂ or YSZ (yttrium stabilized zirconium).

The filter membranes are preferably sintered filter membranes, especially In case the filtration membrane comprises or consists in metal fibers. Metal fiber filter membranes may be provided by the methods as described in WO2005/099863, WO2005/099864 and WO2005/099940.

A metal fiber filter membrane, either sintered or not sintered, may comprise at least a first metal fiber layer which metal fibers of this layer have an equivalent diameter D1. This first metal fiber layer provides a first outer surface to the metal fiber filter membrane. A metal fiber filter membrane may have a mean flow pore size of less than 2 times the equivalent diameter D1.

The mean flow pore size can be measured using a “Coulter Porometer II” testing equipment or equivalent, which performs measurements of the mean flow pore size according to ASTM F-316-80.

The metal fibers of the first metal fiber layer all have an individual fiber length. As some distribution on these fiber lengths may occur, due to the method of manufacturing the metal fibers, the metal fibers of the first metal fiber layer of a metal fiber filter membrane can be characterized using the average fiber length L1.

This length is determined by measuring a significant number of fibers present in the first metal fiber layer, according to appropriate statistical standards. The average fiber length of the metal fibers in the first metal fiber layer may be smaller than 10 mm, e.g. smaller than 6 mm, preferably smaller than 1 mm, such as smaller than 0.8 mm or even smaller than 0.6 mm such as smaller than 0.2 mm.

The metal fibers in the first metal fiber layer in the metal fiber filter membrane, either sintered or not sintered, may have a ratio of average fiber length over diameter (L1/D1) which is preferably less than 110, more preferred less than 105 or even less than 100, but usually more than 30. An L1/D1 of about 30 to 70 is preferred for metal fibers with equivalent diameter in the range up to 6 μm, in case the metal fibers are obtained by the process as described in WO02/057035, hereby incorporated by reference.

Preferably the equivalent diameter D1 of the metal fibers of the first layer of the metal fiber filter membrane is less than 100 μm such as less than 65 μm, more preferably less than 36 μm such as 35 μm, 22 μm or 17 μm. Possibly the equivalent diameter of the metal fibers is less than 15 μm, such as μ14 m, 12 μm or 11 μm, or even more preferred less than 9 μm such as e.g. 8 μm. Most preferably the equivalent diameter D1 of the metal fibers is less than 7 μm or less than 6 μm, e.g. less than 5 μm, such as 1 μm, 1.5 μm, 2 μm, 3 μm, 3.5 μm, or 4 μm.

It is preferred that the metal fiber filter membrane, especially when sintered, has a mean flow pore size of less than 1.5 times the equivalent diameter D1. More preferred, the mean flow pore size of the metal fiber filter membranes is equal or less than the equivalent diameter D1 of the metal fibers of the first metal fiber layer of the metal fiber filter membrane, increased by one μm. This is the case in particular when metal fibers are used, having an equivalent diameter D1 of equal or less than 6 μm, and more in particular when the equivalent diameter D1 is less than 5 μm. Most preferred, metal fibers, either bundle drawn or coil shaved, are used, which have been subjected to a reduction of fiber length by means of a process as described in WO02/057035.

The thickness of the first metal fiber layer of the metal fiber filter membrane, especially when sintered metal fiber filter membrane is used, may vary over a large range, but relatively thin first metal fibers layers may be obtained, e.g. layers with thickness less than or equal to 0.2 mm or even less than or equal to 0.1 mm. Even more surprising, it was found that sintered metal fiber filter membranes having such first metal fiber layers with thickness less than 0.2 mm or less than 0.1 mm, a bubble point pressure of more than 10000 Pa may be obtained. It was also noticed that a high filtration efficiency may be obtained when such sintered metal fiber filter membranes having a first metal fiber layers with thickness less than 0.2 mm or less than 0.1 mm are used as a liquid filter.

The bubble point pressure can be measured using according to the ISO 4003 testing method or equivalent.

The weight of the first metal fiber layer of the metal fiber filter membrane is preferably less than 500 g/m², more preferred less than 400 g/m² or even less than 300 g/m² such as less than 100 g/m² e.g. less than 40 g/m² or even less than 30 g/m².

The porosity of the metal fiber filter membrane, especially a sintered metal fiber filter membrane, may vary over a large range, but it was found that metal fiber filter membrane may have a porosity in the range of 40% to 99%, e.g. less than or equal to 80%, such as in the range of 55% to 80%, more preferred less than or equal to 70%, such as in the range of 55% to 70%.

A metal fiber filter membrane such as a sintered metal fiber filter membrane, may consist of the first metal fiber layer. Alternatively, it is understood that next to the first metal fiber layer providing a first outer surface to the metal fiber filter membrane, the metal fiber filter membrane may comprise an additional porous metal structure. This porous metal structure may be a metal mesh, e.g. a metal welded or braided grid, or expanded metal sheet. The porous metal structure may comprise also one or more additional metal fiber layers. The porous metal structure may as well comprise one or more additional metal fiber layers and a metal mesh, e.g. a metal welded or braided grid, or expanded metal sheet.

The different additional metal fiber layers are not to comprise identical metal fibers, nor should they be of an identical metal fiber content per surface unit or volume. The different additional metal fiber layers may differ from each other in metal fibers, metal fiber content, thickness, weight and other properties.

Preferably the equivalent diameter D2 of the metal fibers of a second and/or further metal fiber layer is larger than the equivalent diameter D1 of the metal fibers of the first metal fiber layer.

Preferably the average fiber length L2 of the metal fibers of a second metal fiber layer is larger than the average fiber length L1 of the metal fibers of the first metal fiber layer.

It is understood that the in case of a sintered metal fiber filter membrane, the first metal fiber layer and the additional layers of the sintered metal fiber filter membrane may be sintered to each other, either in one sintering operation, or after each or some of the layers have been sintered individually. The porosity of the porous metal structure, and of its element and or layers, is preferably larger than the porosity of the first metal fiber layer.

As the first metal fiber layer provides a first outer surface of the metal fiber structure, advantageously this outer surface has a substantially flat surface. With substantially flat is meant that the Ra value, measured over a statistically relevant length, is less than three times the equivalent diameter D1 of the metal fibers present on the first outer layer of the metal fiber filter membrane. More preferred, Ra value of the first outer surface of the metal fiber filter membrane is less then the equivalent diameter D1, for example less than 0.5 times the equivalent diameter D1. Ra value is defined as the arithmetic mean deviation of the surface height from the mean line through the measured profile from the measured length. The mean line is defined so that equal areas of the profile line above and below the line.

Possibly the filter membranes further comprises metal wires or metal expanded plates to reinforce the filter membrane. Metal wires may be present as metal wire mesh or grid. Alternatively or additionally, the filter membrane may comprise metal powder sheets, perforated sheets such as perforated synthetic sheets or expanded synthetic sheets.

The term “porosity P” of a filter membrane is to be understood as 100-D, wherein D is the density of the filter membrane. The density D is the filter membrane consisting from a given material, is the ratio, expressed in percentage, of the weight per volume of the filter membrane over the theoretical weight of that same volume, in case this whole volume would have been provided completely out of said material.

The term “polymer material” hereafter is to be understood as any type of suitable polymer, preferably being thermally resistant to at least 80° C., and having an E-modulus in the range of 20 to 100 N/mm². Suitable polymers are e.g. polyethylene (PE) such as high density polyethylene (HDPE), polyethylene terephthalate (PET), polypropylene (PP), polyester (PES) polycarbonate (PC), polyamide (PA) and polyoxymethylene (POM). Most preferred, polymers are used which can be die-cast.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

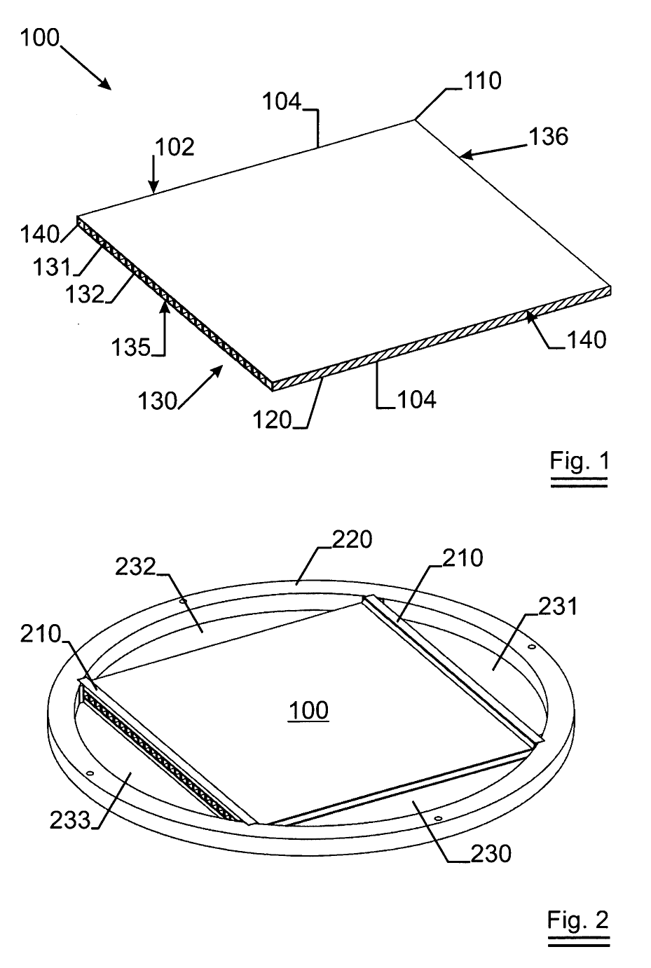

FIG. 1 shows schematically a filter plate 100 according to a first embodiment of the present invention. The filter plate 100 comprises a first filter membrane 110 and a second filter membrane 120. Both filter membranes are substantially parallel to each other and are substantially planar. The membranes may comprise metal fibres such as AISI316L bundle drawn metal fibers. Each membrane comprises three layers, a first layer of short metal fibers obtained using the method as described in WO2005/099863, WO2005/099864 and WO2005/099940 and having an equivalent diameter of 1.5 μm and having an average length over equivalent diameter range of 40 to 100. This first layer has a thickness of about 0.1 mm and has a porosity of about 50%. To this first layer, a second layer is provided, being a metal wire mesh of AISI316L wires having a diameter of 0.1 mm. The mesh has a thickness of about 0.21 mm and a surface weight of 493 g/m². To this second layer, a third layer is provided, being a metal wire mesh of AISI316L wires having a diameter of 0.25 mm. The mesh has a thickness of about 0.5 mm and a surface weight of 1220 g/m².

Between the two filter membranes 110 and 120, a reinforcing means 130 is interposed. The reinforcing means comprises a plurality of rods 131. Each rod is mechanically coupled to at least one of the first membrane 110 or the second membrane 120. Preferably, as shown in FIG. 1, the rods are mechanically coupled to both the first membrane 110 and the second membrane 120. The rods are provided in such a way that they create at least two flow channels 132, for guiding the fluid towards the edge 102 of the plate 100. The reinforcing means 130 spaces the two filter membranes one from the other.

The rods 131 according to the present embodiment are substantially rectangular rods of polyoxymethylene material, having a long side or height of 4 mm and a small side or width of 1 mm.

The rods are coupled to one or both of the filter membranes by means of butt-welding. The rods are coupled to the surface provided by the third layer of filter membranes, being a wire mesh, by means of their short side at a distance of 6 mm centre to centre. As a result, a filter plate is provided having a height of about 5.5 mm. As an alternative, the rods may be coupled to the surface provided by the layer of short metal fibers of filter membranes. In both cases, the side being provided by the short metal fiber layer is preferably used as inflow side of the liquid.

Alternative methods to couple the rods, or more in general the reinforcing means to the filter membranes are gluing, other methods of welding such as ultrasonic welding and laser welding, extrusion, or, in case the rods are metal rods, tig-welding, micro plasma welding, soldering such as high temperature soldering or sintering.

It is understood that also other alternative reinforcing means may be provided, such as an undulated plate of polyethylene terephthalate (PET), having a thickness of in the range of 0.1 to 0.6 mm. The plate is provided with a trapezium-like profile in a plane perpendicular to the surface of the plate. The trapezium-like forms have a height of about 2 mm to 4 mm and have two parallel sides, which smallest of the two sides has a width of about 1 mm. The other, large side of the two substantially parallel sides has a width of about 7 mm.

As another alternative, a polymer plate having thickness of about 3 mm and having at both sides a plurality of studs protruding out of this side. The plate is provided out of e.g. high density polyethylene, and has a thickness of about 1 mm. The studs have a height of about 2 mm.

As an alternative, the reinforcing means is a metal plate of up to 1 mm thickness, and being provided with protrusions around the perforation. As an example, Coniperf® product from Andritz AG may be used.

The filter plate 100 according to this embodiment is provided with a plate closing means 140. Each of the flow channels 132 has two outer ends 135 and 136 along the edge 102. The filter plate comprise a plate closing means 140 being mechanically attached to the edge 102 along at least part of the edge other than the outer ends of the channels. The plate closing means is provided between the first filter membrane 110 and the second filter membrane 120 for sealing the filter plate 100 along at least a part of its edge. The sealing means 140 so-to-say closes the gap 141 between the first membrane 110 and the second membrane 120 along the edge other than the outer ends 135 and 136 of the channels. In the embodiment as shown in FIG. 1, the plate closing means 140 closes none of the outer ends 135 and 136 of the channels. In alternative embodiments, one of the two outer ends of each of the channels may be closed by the sealing means. At least one of the outer ends of each channel is left open in order to enable the fluid to be guided out of the channel.

The plate closing means 140 is provided by coupling a polymer or metal material to at least a part of the edge of the plate, e.g. by gluing, pressure moulding, casting such as casting of a resin, butt welding or any other methods of welding such as ultrasonic welding and laser welding, extrusion, fluid tight folding or, in case the rods are metal rods, tig-welding, micro plasma welding, soldering such as high temperature soldering or sintering. Also a rubber plate closing means may be used.

The plate closing means is provided out of rubber or a polymer material such as any type of suitable polymer, preferably being thermally resistant to at least 80° C., and having an E-modulus of 20 to 100 N/mm². Typical suitable polymers are e.g. polyethylene (PE) such as high density polyethylene (HDPE), polyethylene terephthalate (PET), polypropylene (PP), polyester (PES) polycarbonate (PC), polyamide (PA) and polyoxymethylene (POM). Most preferred, polymers are used which can be die-cast.

The plate 100 has several advantages. The filter plate is self-supporting, due to the presence of the reinforcing means, possibly assisted by the plate closing means.

The flow channels 132 which are provided by the reinforcing means 130 provided an unimpeded guidance of the fluid towards the edges 102 of the filter plate 100. No pressure drop is created in this flow channel as no other means are required (e.g. metal wire meshes or alike) to both space and/or reinforce the filter membranes at the inner side of the flow channels. As an example, when the filter plate is used in such a way that the outer surfaces 104 of the filter membranes 110 and 120, which are facing away from the reinforcing structure, are used as inflow surface of the membranes for the fluid to be filtered, and the filtrate is guided away by means of the flow channels created between the filter membranes, the retained material will create a filter cake at the inflow sides 104. As according to the present invention the flow channels are open, there is no material that will hinder the fluid used for the back flow, back pulse of back flush to flow back in order to act to the cake via the membrane. The pressure pulses or fluid streams during such cleaning operation are used more efficiently.

As the plate closing means 140 is attached to the edge 102 of the plate 100, and the reinforcing means 130 creating flow channels 132 is mechanically coupled to the filter membranes 110 and 120, the plate can be manipulated as one solid part, e.g. to stack several of such plates for creating a filter stack. This advantage is also obtained when the reinforcing means is a plurality of rods, each rod being mechanically coupled to only one of the first membrane or second membrane

The use of filter plates as subject of the present invention simplifies the operation of providing a filter stack, and decreases the possible mistakes, which may occur in case spacing means, sealing means, and filter membranes, possibly reinforced by reinforcing means, are provided as individual parts.

The use of individual parts necessitates the provision of spacing means at each side of each of the membranes. Even more, when spacing means, sealing means, and filter membranes being individual parts are to be stacked, all means are to satisfy the smallest of the tolerances, this is the tolerance of the sealing means. This in order to provide a stack where the plates are sealed at the edge of the membrane, while having spacing means contacting the membranes at each side of the membrane. Such small tolerances are difficult to meet by the spacing means, and cause often membranes having unsupported zones or zones where the spacing means impinges in the membrane, because the dimensions of the spacing means exceed the maximum tolerated dimension.

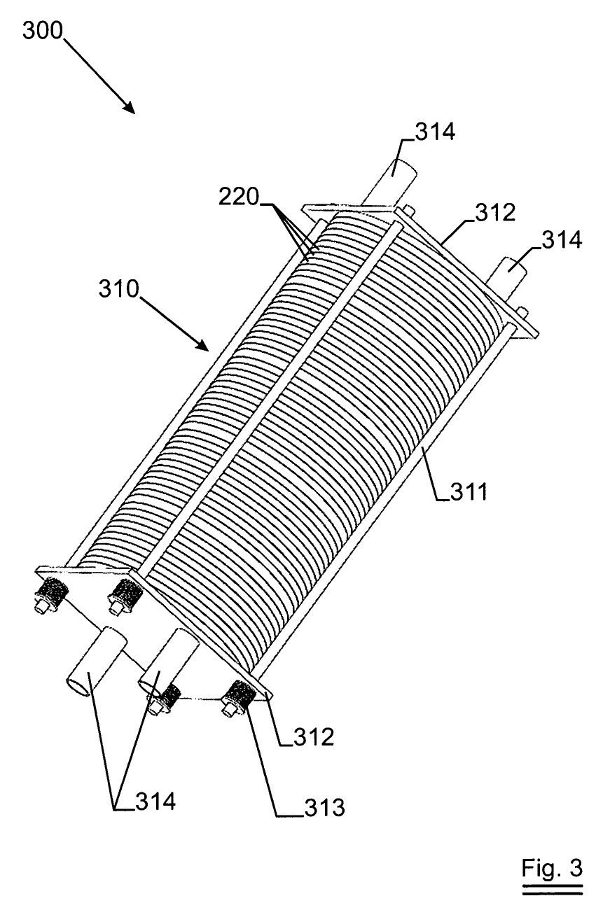

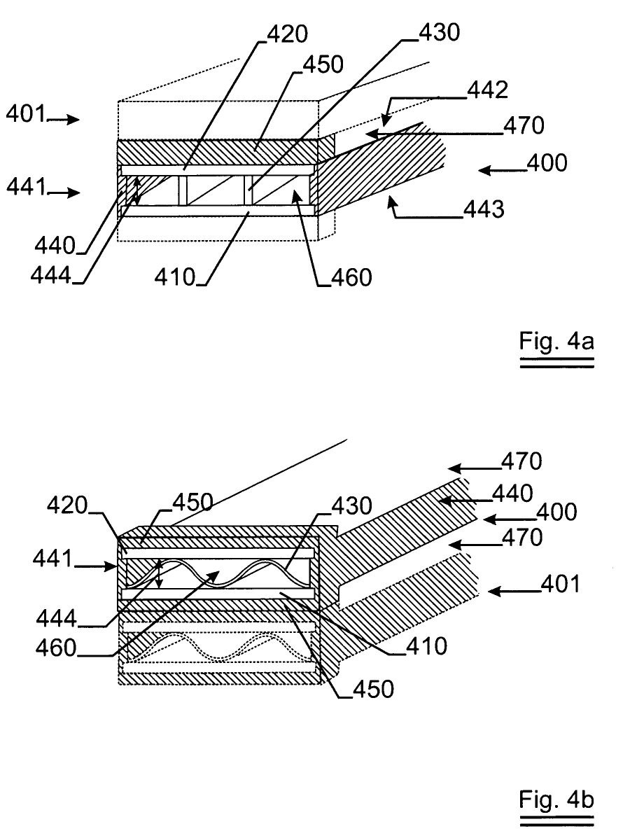

The filter plate 100 can easily be used to provide a filter stack 300 as shown in FIG. 3. As shown in FIG. 2, the outer sides 104 of the filter membranes 110 and 120, which are facing away from the reinforcing structure, are provided with a means for creating at least one flow channel for guiding the fluid between two filter plates 100 when two filter plates are stacked one to the other. A gasket 210, which is to separate the membranes of the different adjacent filter plates and which create a flow channel between two adjacent filter plates, when the plates are assembled to provide a filter stack 300, may be provided as a separate part.

The gasket may be provided out of any suitable material, such as polymer material, preferably compressible sealing material. As an example bi-component silicon such as Elastosil® M4601 A/B or Elastosil® M4600A/B or Elastosil® M4642 A/B of the company Wackers or rubber may be used.

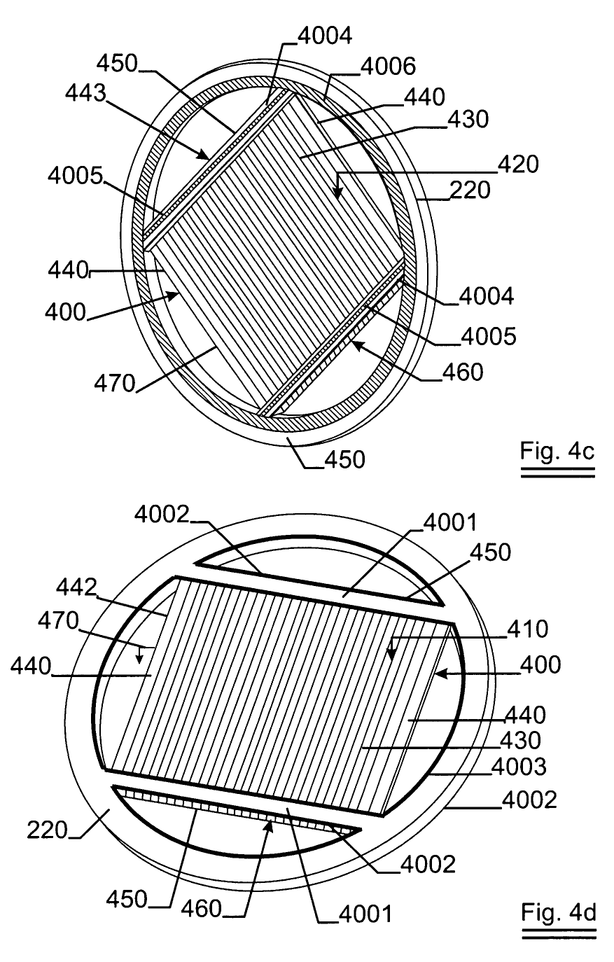

As will be further described in FIG. 4c, the gasket may be attached to the filter membrane at the surface of the filter membrane facing away from the reinforcing means. The gasket may comprise two cooperating rigid frames, the first of the frames being provided to a first side of a first filter plate, the other frame is provided to the second side of a first filter plate. The first frame of a first filter plate is to cooperate with the second frame of a second neighbouring plate, facing to the first filter plate. The first frame is a rigid frame, e.g. a POM or HDPE rigid frame, having a recess along its length in which a sealant is provided. The other frame is provided with a protrusion along its length, which protrusion fits into the recess. When the two frames are pressed one to the other while stacking several filter plates, the sealant is compressed in the recess and thereby seals the two frames in liquid tight way.

An example of a filter plate is shown more in detail in FIG. 4a. Two filter plates 400 and 401 are shown, stacked one to the other. The filter plate 400 comprises two filter membranes 410 and 420, both coupled to the reinforcing means 430 as subject of the present invention for providing flow channels 460. At the edge 441 of the filter plate 400, a plate closing means 440 is provided between the two filter membranes 410 and 420, closing the gap as indicated 444. At a first the outer sides 442 of the filter plate 440, a gasket 450 is provided between the two filter plates 400 and 410. This gasket causes a flow channel 470 to be created between the two adjacent filter plates 400 and 401.

The gasket 450 may be attached to the outer side 442 of the filter plate, or may be provided as an individual part.

An alternative is shown in FIG. 4b. Identical references refer to identically objects and having the same technical effect. The reinforcing means is an undulated polymer plate. Both outer sides 104 are provided with a gasket 450. When two filter plates 400 and 401 are stacked, the two gaskets 450, one from the first filter plate 401 and the other from a second adjacent plate 401, form together a means for creating at least one flow channel 470 for guiding the fluid between two filter plates. The embodiment of FIG. 4b shows gasket and a plate closing means, which form one part. It is understood that alternatively the gasket and the plate closing means may be two individual parts. The gasket may be attached to the filter membrane.

Another alternative is shown in FIG. 4c and FIG. 4d. Identical references refer to identically objects and having the same technical effect as in FIG. 4a and FIG. 4b. For the sake of clarity, the ribs 430 are indicated in FIG. 4c and FIG. 4d, by way of reference to the lines along which the membranes and the ribs are coupled, e.g. welded.

A gasket 450 is provided between the two adjacent filter plates 400 and 410. The gasket causes a flow channel 470 to be created between the two adjacent filter plates 400 and 401. The gasket is provided by means of two cooperating rigid frames, one frame of each neighbouring filter plate.

As shown in FIG. 4d, at a first the outer sides 442 of the filter plate 400, the part of the gasket comprises a polymer rigid frame comprising two upwards walls 4002, creating a recess 4001 along the gasket 450. The walls 4002 are continued along the inner edge of a frame 220, as indicated with 4003.

As shown in FIG. 4c, at the opposite side 443 of the filter plate 400, the gasket comprises a polymer rigid frame comprising a substantially flat upper surface 4004 on which a protruding rib 4005 is provided along the gasket 450. The rib 4005 is continued along the inner edge of a frame 220, as indicated with 4006. The recess 4001 and the rib 4005 are located in such a way that when two adjacent filter plates, together with their frames 220, are brought one on top of the other, the rib 4005 is sunk into the recess 4001 of the adjacent frame. A sealing material, such as e.g. as Elastosil® M4601 A/B or Elastosil® M4600A/B or Elastosil® M4642 A/B of the company Wackers, is provided in the recess 4001 and along the outer frame (e.g. an O-sealing ring). The sealant is compressed in the recess and between the two adjacent frames along the outer circular part of the frame 220. A fluid tight seal between two adjacent frames is so obtained.

As further shown in FIG. 2 and FIG. 4c and FIG. 4d, the substantially rectangular, more particular the substantially square filter plate is provided in a circular frame 220. This frame is used for the construction of a filter stack 300 as shown in FIG. 3. The plate has dimensions of 195 mm square, and a total thickness of about 5.5 mm. The outer diameter of the circular frame is about 320 mm and the frame is made out of polymer material such as polyethylene (PE), preferably high density polyethylene (HDPE), or polyoxymethylene (POM). It may be provided, e.g. cast, along with the rigid frames of the gasket, forming one single element.

The open areas 230, 231, 232 and 233 between frame and a side of the filter plate create channels for providing fluid to or guiding fluid away from the filter plate. The channels 132 of the filter plate extending in the open areas 231 and 233. The channels between two adjacent plates will communicate with the open area 230 and 232, when the filter stack 300 is assembled. Aligning the rods substantially parallel to one of the sides of the rectangular shape provides the follow channels, having open ends at the edge of the rectangular shape, perpendicular to the side along which the rods are aligned.

Several filter plates and additional gasket, mounted in a frame, are stacked and clamped by means of a clamping device 310, e.g. two metal plates 312 each of them being provided at one side of the stack of filter plates, and applying a pressure to the stack by means of four threaded rods 311 coupled to the metal plates by welds or bolts 313. It is understood that other clamping devices may be sued as well.

Depending on the type of filtration system, appropriate coupling means 314 are provided to couple the open areas 230, 231, 232 and 233 to either a fluid supply or discharge outlet. Appropriate coupling of the coupling means may cause the filter stack to work as cross-flow or dead-end filter stack.

The gasket, together with filter plates as subject of the present invention, allow an easy assembling of a filter stack, by alternating a filter plate and a gasket. By applying a clamping force to the outer ends of the stack, the gasket will seal the space provided between two adjacent filter plates. The void space between the filter plates so obtained, provide a guiding channel for fluid provided to or removed from the filter membranes of the filter plates.

As the filter plates are self supporting because of the reinforcing means and the plate sealing mean, tolerances of the filter stack in order to seal the plates and the fluid channels between the plates can easily be met, and doesn't require additional precautions

The flow channels between adjacent filter plates may be open and does not require additional supporting means, as the plates are self-supporting. Because such open flow channels between adjacent plates may be provided, again no additional pressure drops are provided to the fluid for both flowing to or away from the membranes, not for the fluid used to clean the membranes by back washing, pulsing or flowing. In case the filter membrane surfaces facing away from the reinforcing means are used as inflow side, the filter cake, when broken into different cake parts during cleaning, can easily be evacuated as no obstacles are present to prevent the cake parts from flowing out of the void space between two adjacent filter plates. A more efficient cleaning is provided.

As less pressure drops are created in the filter stack, the yield of the filter stack using a given filter pressure in increased as compared to presently known filter stacks.

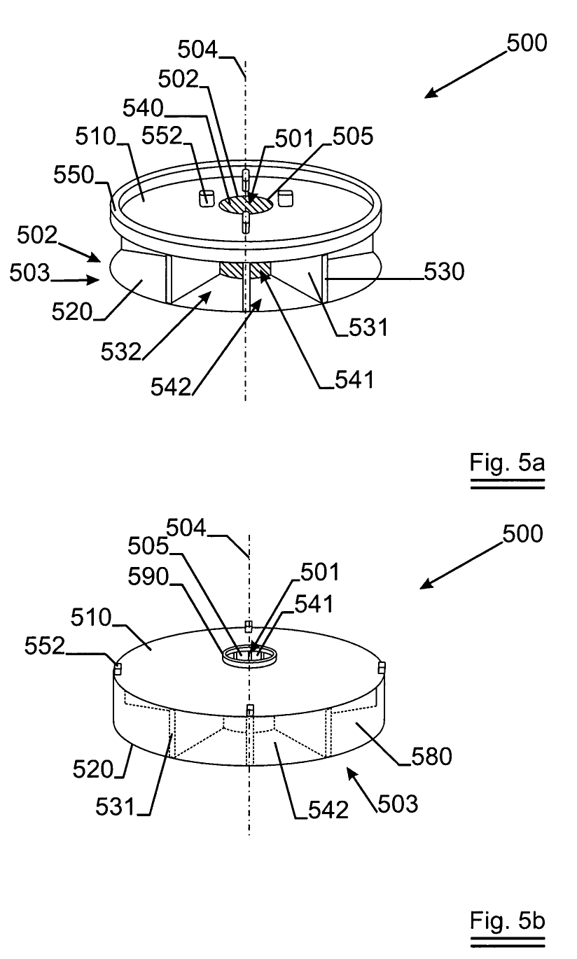

An alternative embodiment of the present invention is shown in FIG. 5a. A circular filter plate 500 comprises two filter membranes 510 and 520. The filter plate 500 has a donut-shape, having an inner circular open area 501, substantially concentric with the outer edge 503 of the plate 500. The edge 502 comprises an outer edge 503 and an inner edge 505 along the inner open area 501. The reinforcing means 530 comprises a number of rods 531 which extend from the centre 504 of said circular shape to the outer edge 503 at the outer side of the circular shape of the plate 500. These rods create flow channels 532 extending in radial direction from the inner open area 501 towards the outer edge 503 of the plate. A first outer end 541 of the flow channel 532 is provided at the inner edge 505 of the filter plate. The second outer end 542 of each flow channel 532 is provided at the outer edge 503. The inner edge 505 is closed by means of a plate closing means 540, closing the gap between the two filter membranes along the inner edge 503, and closing the outer ends 541 of the channels, while leaving open the other outer ends 542 of the channels. Along the outer edge 503, a gasket 550 is provided, which is to separate the membranes of the different adjacent filter plates, and which creates a flow channel between two adjacent filter plates. Along the inner edge 505, several studs 552 are provided to maintain the distance between adjacent plats along the inner open area.

Several plates 500 and gasket may be stacked to provide an alternative filter stack as subject of the present invention.

Alternatively, as shown in FIG. 5b, the outer edge 503 is closed by means of a plate closing means 580, closing the gap between the two filter membranes along the outer edge 503, and closing the outer ends 542 of the channels, while leaving open the other outer ends 541 of the channels. Along the inner edge 505, a gasket 590 is provided, which is to separate the membranes of the different adjacent filter plates, and which create a flow channel between two adjacent filter plates. Along the outer edge 505, several studs 552 may be provided to maintain the distance between adjacent plats along the inner open area. Several plates 500 and gasket may be stacked to provide an alternative filter stack as subject of the present invention.

The used materials to provide the filter membranes rods, plate closing means and gasket as shown in FIG. 5a and FIG. 5b are similar to the materials used to provide the filter plate and filter stack as shown in FIGS. 1 and 2.

It is to be understood that although preferred embodiments, specific constructions and configurations, as well as materials, have been discussed herein for devices according to the present invention, various changes or modifications in form and detail may be made without departing from the scope and spirit of this invention.

1-14. (canceled)

15. A filter plate for filtration of a fluid, said plate having an edge and comprising a first filter membrane and a second filter membrane, said first filter membrane and said second filter membrane being substantially planar and said first filter membrane and said second filter membrane being substantially parallel, said first filter membrane and said second filter membrane comprising metal fibers, said filter plate comprising a reinforcing device interposed between said filter membranes, said first filter membrane and said second filter membrane being attached to said reinforcing device, said reinforcing device defining at least two flow channels between said filter membranes arranged to guide a fluid being filtered towards said edge.

16. The filter plate as in claim 15, wherein said reinforcing device is made from polymer material.

17. The filter plate as in claim 15, wherein said reinforcing device is made from metal material.

18. The filter plate as in any one of the claims 15 to 17, wherein said first filter membrane and said second filter membrane further comprise at least one of a metal wire grid or an expanded metal sheet.

19. The filter plate as in claim 15, wherein each of said flow channels comprises two outer ends along said edge, said filter plate comprising a plate closure, said plate closure being attached to said edge along at least part of said edge other than said outer ends of said channels, said plate closure being provided between said first filter membrane and said second filter membrane and sealing the filter plate along said at least part of said edge.

20. The A filter plate as in claim 19, wherein said filter plate includes two outer sides facing away from said reinforcing device, said filter plate further comprising a gasket being attached to at least one of said outer sides of said filter plate along at least part of said edge that defines at least one flow channel for guiding a fluid between two filter plates when two filter plates are stacked one to the other.

21. The filter plate as in claim 15, wherein said reinforcing device is a corrugated plate.

22. The filter plate as in claim 15, wherein said reinforcing device is a plate having two outer sides, and a plurality of ribs protruding out of each outer side.

23. The filter plate as in claim 15, wherein said reinforcing device comprises a plurality of rods.

24. The filter plate as in claim 15, wherein said filter plate has a substantially circular shape having a substantially circular outer edge.

25. The filter plate as in claim 15, wherein at least one of the first filter membrane or the second filter membrane comprises at least a first metal fiber layer, the metal fibers of which have an equivalent diameter D1, and the at least one of the first filter membrane or the second filter membrane has a mean flow pore size of less than 2 times the equivalent diameter D1.

26. The filter plate as in claim 25, wherein at least one of the first filter membrane or the second filter membrane comprises at least a second metal fiber filter layer.

27. The filter plate as in claim 26, wherein the second metal fiber layer comprises metal fibers having an equivalent diameter D2 being larger than the equivalent diameter D1 of the metal fibers of the first metal fiber layer.

28. The filter plate as in claim 15, wherein the first filter membrane and the second filter membrane are identical.
